(19) United States
(12) Patent Application Publication
(10) Pub. No.: US 2019/0360065 A1
(43) Pub. Date: Nov. 28, 2019

(54) METHOD FOR PRODUCING A STRIP FROM A CoFe ALLOY AND A SEMI-FINISHED PRODUCT CONTAINING THIS STRIP

(71) Applicant: Vacuumschmelze GmbH & Co. KG, Hanau (DE)

(72) Inventors: Niklas VOLBERS, Bruchköbel (DE); Jan, Frederik FOHR, Rödermark (DE)

(21) Appl. No.: 16/461,720

(22) PCT Filed: Nov. 17, 2017
(86) PCT No.: PCT/EP2017/079682

§ 371 Date: May 16, 2019

(30) Foreign Application Priority Data
Nov. 18, 2016 (DE) 10 2016 222 805.6

(51) Int. Cl. C21D 8/12; C22C 19/07; C22C 38/10; C22C 38/12; H01F 1/147

(52) U.S. Cl. CPC C21D 8/1222; C21D 8/1261; C21D 8/1266; C21D 8/1272; H01F 1/147; C22C 38/10; C22C 38/12; C21D 8/1233; C22C 19/07

(57) ABSTRACT

A semi-finished product comprising at least one metal strip is provided. The metal strip consists essentially of 35 wt %≤Co≤55 wt %, 0 wt %≤V≤3 wt %, 0 wt %≤Ni≤2 wt %, 0 wt %≤Nb≤0.50 wt %, 0 wt %≤Zr+Ta≤1.5 wt %, 0 wt %≤Cr≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % of impurities. The strip has a thickness d, where 0.05 mm≤d≤0.5 mm, a Vickers hardness greater than 300, an elongation at fracture of less than 5% and, after heat treatment of the strip at a temperature of between 700° C. and 900° C.

This application is a 371 national phase entry of PCT/EP2017/079682 filed on 17 Nov. 2017, which claims benefit of German Patent Application No. 10 2016 222 805.6, filed 18 Nov. 2016, the entire contents of which are incorporated herein by reference for all purposes.

### BACKGROUND

### 1. Technical Field

The invention relates to a semi-finished product, in particular a semi-finished product having at least one strip made of a CoFe alloy, and a method for producing a CoFe alloy.

### 2. Related Art

Soft magnetic cobalt-iron alloys (CoFe) with a Co content of 49% are used for their high saturation polarisation. A CoFe alloy class has a composition of 49 wt % Fe, 49 wt % Co and 2% V and which may also contain additions of Ni, Nb, Zr, Ta or B. In a composition of this kind, a saturation polarisation of approx. 2.3 T and a sufficiently high electrical resistance of 0.4 μΩm are achieved simultaneously.

Alloys of this kind are used as high saturation flux conductors, for example, but also in applications in electrical machines. When they are used in generators and motors, it is typically in the form of laminated packages for stators and rotors. Here the material is used in strip thicknesses within a range of 0.50 mm to very thin dimensions of 0.050 mm.

To achieve the required magnetic properties, the material is subjected to heat treatment, also referred to as final magnetic annealing. This heat treatment takes place at above the recrystallisation temperature and below the phase transition α/γ, generally within a range of 700° C. to 900° C.

In contrast to electrical sheets made of iron-silicon (FeSi), strip made of CoFe is typically not offered for sale already finally annealed. Finally annealed strip is both soft due to its recrystallized structure and brittle due to ordering, and is therefore insufficiently suitable for punching. Moreover, cutting and punching processes lead to a significant deterioration in its magnetic properties. As a result, after forming CoFe sheets undergo final annealing, either as metal sheets, single laminations or finished stacks of sheets.

However, final magnetic annealing also modifies the dimensions of the sheet. This longitudinal growth lies within a range of 0.03% to 0.20%.

Where such growth is known, it is possible to offset isotropic growth within certain limits by setting an allowance on the punching tool and/or to rework or refinish the sheets or stack of sheets, as disclosed in WO 2007/009442 A2, for example. Processes of this kind are associated with higher costs and are not always practical depending on the geometry.

### SUMMARY

The object is, therefore, to disclose a CoFe alloy and a method for producing a CoFe alloy that exhibits reduced growth following final magnetic annealing.

According to the invention, one embodiment discloses a method for producing a CoFe alloy comprising the following. First a molten material is provided consisting essentially of 35 wt %≤Co≤55 wt %, 0 wt %≤V≤3 wt %, 0 wt %≤Ni≤2 wt %, 0 wt %≤Nb≤0.50 wt %, 0 wt %≤Zr+Ta≤1.5 wt %, 0 wt %≤Cr≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % impurities, it being possible for these impurities to contain one or more from the group O, N, S, P, Ce, Ti, Mg, Be, Cu, Mo and W, wherein wt % denote weight percent. The molten material is cast in a vacuum and then solidified to form an ingot. The ingot is hot-rolled to form a slab and then a hot-rolled strip of thickness D₁. The hot-rolled strip is then quenched from a temperature of above 700° C. to a temperature of less than 200° C. The hot-rolled strip is cold-rolled to form an intermediate strip of thickness D₂, this intermediate strip is intermediately annealed continuously (i.e. in a continuous process) at a temperature of above 700° C. and cooled in a gaseous medium at a temperature of above 700° C. to a temperature of less than 200° C. The heat-treated intermediate strip is cold-rolled with a bright metal surface to form a strip of thickness D₃, the degree of cold deformation being (D₂−D₃)/D₂≤80%, preferably 60%.

No quenching or pickling is carried out after intermediate continuous annealing of the cold-rolled intermediate strip and the heat-treated intermediate strip therefore has a bright metal surface. The heat-treated intermediate strip with this bright metal surface is further processed by means of further cold-rolling. This simplifies the production process. In addition, the degree of cold deformation of the last cold-rolling step is limited, permitting the resulting strip to exhibit a growth dl/l₀ in the longitudinal direction of the strip of less than 0.08%, preferably 0.06%, and/or in the transverse direction of the strip of less than 0.08%, preferably 0.06%, after final magnetic annealing, i.e. after heat treatment at a temperature of between 700° C. and 900° C. Here l₀ denotes the starting length before final annealing, dl the absolute variation in length after final annealing and dl/l₀ the relative variation in length in relation to the starting length.

The final magnetic annealing of this CoFe alloy takes place at above the recrystallisation temperature and below the phase transition α/γ. The recrystallisation temperature and the temperature at which the α/γ phase transition takes place are dependent on the composition of the CoFe alloy. Final magnetic annealing is generally carried out within a range of 700° C. to 900° C. An ordering takes place during the subsequent cooling, i.e. a B2 superstructure is formed. Final magnetic annealing and the associated ordering results in a permanent variation in the dimensions of the sheet at room temperature or in permanent longitudinal growth. A strip with a starting length l₀ at room temperature before final annealing therefore has a length of l₀+dl after final annealing and at the same room temperature. In some embodiments dl is greater than 0.

This permanent longitudinal growth is reduced by means of the method according to the invention. According to the invention, the permanent growth dl/l₀ is less than 0.08%, preferably 0.06%, in the longitudinal direction of the strip and/or less than 0.08%, preferably 0.06%, in the transverse direction of the strip. This low permanent growth rate is not achieved in strips made from a CoFe alloy that are produced with a degree of cold deformation in the last cold-rolling step greater than 80%.

It has been established that an important factor influencing the extent of this growth in the degree of cold deformation (CD) is that the greater the cold deformation of the material, the more pronounced the longitudinal growth after final annealing. By using intermediate annealing it is possible to reduce the degree of cold deformation in the last step such that the strip exhibits reduced longitudinal growth after final magnetic annealing.

The strip thickness achieved by hot-rolling and/or cold-rolling and the strip thickness at which intermediate annealing is carried out can be defined more precisely. For example, the strip can have a thickness D₁ of 1.0 mm≤D₁≤2.5 mm after hot-rolling, a thickness D₂ of 0.1 mm≤D₂≤1.0 mm before intermediate annealing and/or a thickness D₃ of 0.05 mm≤D₃≤0.5 mm after second cold-rolling.

In one embodiment, the thickness of the hot-rolled strip is reduced from D₁ to D₂ by means of cold-rolling and/or the thickness of the intermediate strip is reduced from D₂ to D₃ by means of cold-rolling. As a result no further intermediate annealing processes are carried out.

The conditions for intermediate continuous annealing, i.e. intermediate annealing in a continuous process, are selected such that the strip can be cold-rolled after intermediate annealing. In one embodiment, after intermediate annealing the intermediate strip has a structure in which a ferritically recrystallised fraction has an average grain size of less than 10 μm and/or a ferritically recrystallised fraction has no grains of a size greater than 10 μm. This structure can be produced by means of a temperature of 800° C. to 900° C., for example.

In one embodiment, after intermediate annealing the intermediate strip can be bent a number of times in an alternating bend test before it fractures, the number being at least 20. The alternating bend test can be used to determine the cold formability of the strip.

Intermediate continuous annealing can be carried out a speed of 1 m/min to 10 m/min and the length of time the strip spends in the heating zone of the continuous furnace at a temperature of 700° C. to 1100° C., preferably 800° C. to 1000° C., can be between 30 seconds and 5 minutes. The intermediate continuous annealing of the intermediate strip can take place at a temperature of 800° C. to 900° C. or of 1000° C. to 1100° C. Depending on the length of the heating zone of the continuous furnace, it is possible to adjust the annealing temperature and strip speed parameters in order to obtain the properties described here.

After intermediate annealing the strip can essentially have a deformation structure or a mixed structure with fractions of a former γ-phase in a α-phase matrix. A deformation structure can be achieved at a temperature of 800° C. to 900° C., for example. A mixed structure with fractions of a former γ-phase in a α-phase matrix can be achieved at a temperature of 1000° C. to 1100° C.

Intermediate annealing can be carried out in an inert gas or a dry hydrogen-containing atmosphere with a saturation temperature of less than −30° C. After intermediate continuous annealing, the intermediate strip is cooled to a temperature of less than 200° C. in a gaseous medium such as an insert gas or a dry hydrogen-containing atmosphere. However, the intermediate strip is not quenched, e.g. in water.

In an alternative method the degree of deformation of hot-rolling is adjusted such that the degree of deformation of cold-rolling remains below a predetermined limit such that longitudinal growth after final magnetic annealing remains low. This method for producing a CoFe alloy comprises the following. A molten material consisting essentially of 35 wt %≤Co≤55 wt %, 0 wt %≤V≤3 wt %, 0 wt %≤Ni≤2 wt %, 0 wt %≤Nb≤0.50 wt %, 0 wt %≤Zr+Ta≤1.5 wt %, 0 wt %≤Cr≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % of impurities is provided, these impurities can contain one or more from the group O, N, S, P, Ce, Ti, Mg, Be, Cu, Mo and W. The molten material is cast in a vacuum and then solidified to form an ingot. The ingot is hot-rolled to form a slab and then a strip of thickness D₁, where 1 mm≤D₁<2 mm. The strip is then quenched from a temperature of above 700° C. to a temperature of less than 200° C. The strip is cold-rolled and the thickness is reduced from D₁ to a thickness D₂, the degree of cold deformation being (D₁−D₂)/D₁ 80%, preferably 60%.

In this method the degree of deformation of the hot-rolling and thus the thickness D₁ of the strip after hot-rolling and before cold-rolling is set such that the desired final thickness D₂ can be achieved with a degree of deformation of less than 80%, preferably less than 60%. Typically, the degree of deformation of hot-rolling is increased and the degree of deformation of cold-rolling reduced accordingly compared to a conventional commercial method.

In one embodiment, the final thickness D₂ is 0.05 mm≤D₂≤0.5 mm. The heat treatment of the strip can take place in a dry hydrogen-containing atmosphere.

The two alternative methods can also comprise the forming of at least one sheet from the strip. The sheet can be punched out of the strip. A plurality of sheets can be assembled to form a stack of sheets. The strip or sheet or stack of sheets can also be heat treated at a temperature of between 700° C. and 900° C., i.e. final magnetic annealing can be carried out. This heat treatment takes place at above the recrystallisation temperature and below the temperature of the phase transition α/γ, generally within a range of 700° C. to 900° C. Ordering takes place during the subsequent cooling, i.e. a B2 superstructure is formed, and the desired magnetic properties, for example a saturation polarisation of approx. 2.3 T and an electrical resistance of 0.4 μΩm, are created.

After this heat treatment of the strip, growth dl/l₀ in the longitudinal direction of the strip is less than 0.08% and/or in the transverse direction of the strip is less than 0.08% and/or a difference between growth in the longitudinal direction and growth in the transverse direction of the strip is less than 0.06%, preferably less than 0.04%. Here l₀ denotes the starting length before final annealing, dl the absolute variation in length after final annealing and dl/l₀ the relative variation in length in relation to the starting length.

This growth is permanent growth caused by final magnetic annealing and the associated ordering. A strip with a starting length l₀ at room temperature before final annealing therefore has a length of l₀+dl after final annealing at the same room temperature.

According to the invention, in one embodiment a semi-finished product is provided that comprises at least one metal strip consisting essentially of 35 wt %≤Co≤55 wt %, 0 wt %≤V≤3 wt %, 0 wt %≤Ni≤2 wt %, 0 wt %≤Nb≤0.50 wt %, 0 wt %≤Zr+Ta≤1.5 wt %, 0 wt %≤Cr≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % impurities, the impurities may contain one or more from the group O, N, S, P, Ce, Ti, Mg, Be, Cu, Mo and W. The strip has a thickness d, where 0.05 mm≤d≤0.5 mm, a Vickers hardness greater than 300 and an elongation at fracture of less than 5%. After heat treatment of the strip at a temperature of between 700° C. and 900° C., the strip exhibits growth dl/l₀ in the longitudinal direction of the strip of less than 0.08%, preferably 0.06%, and/or in the transverse direction of the strip of less than 0.08%, preferably 0.06%.

This semi-finished product therefore has mechanical properties that are present in a cold-rolled state, i.e. an elongation at fracture of less than 5% and a Vickers hardness greater than 300. This semi-finished product can be further processed, for example to form sheets from the strip and to assemble the sheets into a stack of sheets that is heat treated to adjust its magnetic properties. This heat treatment of the strip is referred to as final magnetic annealing as it serves to adjust magnetic properties, and can be carried out at a temperature of between 700° C. and 900° C.

This growth is permanent growth caused by final magnetic annealing and the associated ordering. A strip with a starting length of l₀ at room temperature before final annealing therefore has a length of l₀+dl after final annealing at the same room temperature. In some embodiments dl is greater than 0.

The strip according to the invention makes it possible to produce laminations, to subject these laminations to final annealing in order to set optimum magnetic properties and then to achieve dimensional accuracy sufficiently high to ensure that no further geometrical correction is required. The possible disadvantages of retrospective geometrical correction, which may be effected by grinding, for example, are deterioration of magnetic permeability at the points in question, the risk of eddy currents since grinding can result in smeraring of the lamella, and higher costs. As a result, in applications such as stators and rotors, for example, it is possible to set smaller air gaps, thereby increasing the efficiency of the electrical machine.

In one embodiment, the strip can have a lesser thickness, e.g. a thickness where 0.05 mm≤d≤0.356 mm. Moreover, the semi-finished product can have a plurality of sheets that form a stack of sheets.

In one embodiment, after heat treatment of the strip at a temperature of between 700° C. and 900° C., the difference between permanent growth in the longitudinal direction and permanent growth in the transverse direction of the strip is less than 0.06%, preferably less than 0.04%.

The CoFe-strip according to the invention with clearly reduced growth has the further advantage that it makes it possible to design a punching tool that can be used both for CoFe and for other alloys such as SiFe. This results in an economic advantage given the high cost of such a tool.

Various CoFe alloy can be used. In other embodiments the CoFe alloy has one of the following compositions:

35 to 55 wt % Co, up to 2.5 wt % V, remainder Fe and up to 1 wt % impurities, e.g. 49 wt % Co, 49 wt % Fe and 2 wt % V;

45 wt %≤Co≤52 wt %, 45 wt %≤Fe≤52 wt %, 0.5 wt %≤V≤2.5 wt %, remainder Fe and up to 1 wt % impurities;

35 wt %≤Co≤55 wt %, preferably 45 wt %≤Co≤52 wt %, 0 wt %≤Ni≤0.5 wt %, 0.5 wt %≤V≤2.5 wt % and up to 1 wt % impurities;

35 wt %≤Co≤55 wt %, 0 wt %≤V≤2.5 wt %, 0 wt %≤(Ta+2Nb)≤1 wt %, 0 wt %≤Zr≤1.5 wt %, 0 wt %≤Ni≤5 wt %, 0 wt %≤C≤0.5 wt %, 0 wt %≤Cr≤1 wt %, 0 wt %≤Mn≤1 wt %, 0 wt %≤Si≤1 wt %, 0 wt %≤Al≤1 wt %, 0 wt %≤B≤0.01 wt %, remainder Fe and up to 1 wt % impurities;

47 wt %≤Co≤50 wt %, 1 wt %≤V≤3 wt %, 0 wt %≤Ni≤0.25 wt %, 0 wt %≤C≤0.007 wt %, 0 wt %≤Mn≤0.1 wt %, 0 wt %≤Si≤0.1 wt %, 0.07 wt %≤Nb≤0.125 wt %, 0 wt %≤Zr≤0.5 wt %, remainder Fe and up to 1 wt % impurities; or

49 wt %≤Co≤51 wt %, 0.8 wt %≤V≤1.8 wt %, 0 wt %≤Ni≤0.5 wt %, remainder Fe and up to 1 wt % impurities.

CoFe-based alloys are available under the trade names VACOFLUX 50, VACOFLUX 48, VACODUR 49, VACODUR 50, VACODUR S Plus, Rotelloy, HIPERCO 50, Permendur, AFK and 1J22.

The impurities can contain one or more from the group O, N, S, P, Ce, Ti, Mg, Be, Cu, Mo and W.

Exemplary embodiments are explained in greater detail below with reference to the drawings and the following examples.

### BRIEF DESCRIPTION OF THE DRAWINGS

FIG. 1 shows a graph of measured average growth dl/l0 after final annealing of strips that are cold-rolled to different thicknesses d.

FIG. 2 shows a graph of yield strength R_{p0.2} and tensile strength Rₘ dependent on the temperature of continuous annealing.

FIG. 3 shows optical images of the structure of three samples after intermediate annealing at different temperatures.

FIG. 4 shows magnetisation curves B(H) after various intermediate annealing steps and final annealing.

FIG. 5 shows a graph of the measured variation in length in the direction of rolling as compared to the degree of cold deformation for two different samples.

### DETAILED DESCRIPTION OF EXAMPLE EMBODIMENTS

It has been shown that the longitudinal growth of a strip made of a CoFe alloy after final annealing can be reduced by limiting the degree of cold deformation.

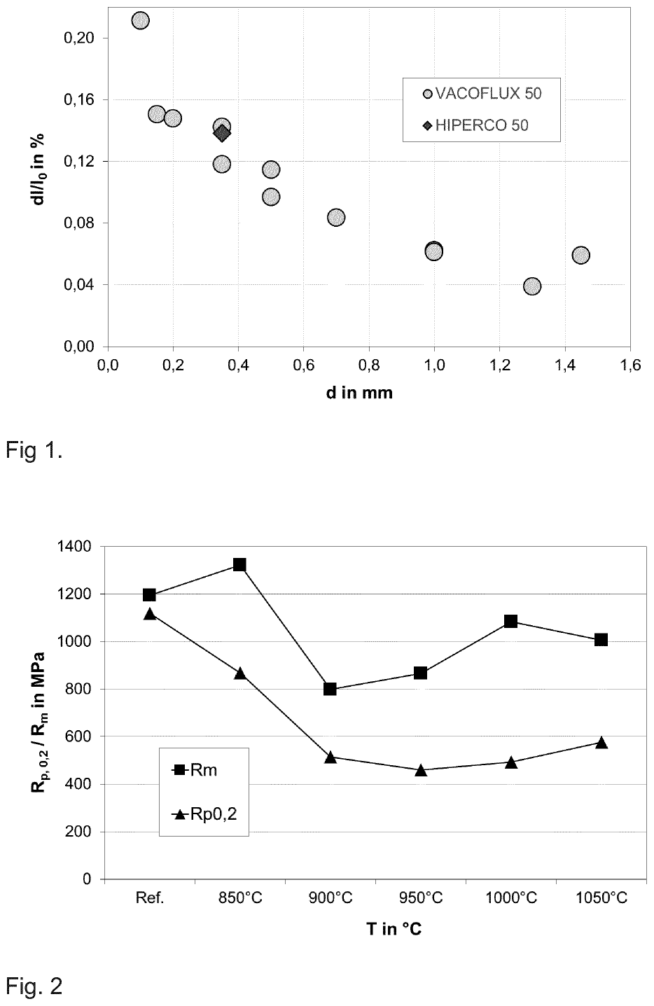

FIG. 1 shows a graph of average growth dl/l0 measured after final annealing in % in longitudinal direction on the 50% CoFe material VACOFLUX 50 (49Fe-49Co-2V) and on HIPERCO 50 (49Fe-49Co-2V) as a comparative example. The samples examined had a thickness after hot-rolling of 2 mm or greater and are cold-rolled to different final thicknesses and so subjected to different degrees of cold deformation. l₀ denotes the starting length before final annealing, dl the absolute variation in length after final annealing and dl/l₀ the relative variation in length in relation to the starting length.

This variation in length or growth is a permanent variation in length or permanent growth caused by final magnetic annealing and the associated ordering. A sample with a starting length l₀ at room temperature before final annealing thus has a length of l₀+dl after final annealing and at the same room temperature.

While a small permanent longitudinal growth compared to the starting length within a range of 0.03% to 0.05% continues to be measured at room temperature on hot-rolled material, i.e. with 0% cold deformation (CD), a strip with a strip thickness of 0.35 mm already shows permanent growth of over 0.10%. At even higher cold deformation, e.g. to a strip thickness of 0.10 mm, permanent growth of over 0.20% takes place. This permanent variation in longitudinal growth is presumably due to an increasingly pronounced texture. These results show that an important influencing factor on the extent of this growth in the degree of cold deformation is that the greater the cold deformation of the material, the more pronounced the longitudinal growth after final annealing.

Consequently, these results show that the permanent variation in longitudinal growth can, in principle, be reduced if the degree of cold deformation is reduced. In principle, the degree of cold deformation can be reduced by carrying out intermediate annealing between two cold deformation steps, each with a relatively small degree of cold deformation. Due to the ordering due to intermediate annealing, however, a CoFe alloy then becomes brittle and ceases to be workable. This brittleness is then conventionally removed by means of a subsequent quenching process. However, this quenching process is time consuming and associated with technical disadvantages and high costs.

According to the invention, the reduction of the degree of cold deformation at a predetermined final thickness is achieved by the introduction of intermediate annealing or by reducing the hot-rolling thickness.

According to the invention, intermediate annealing is carried out continuously (i.e. in a continuous process) and so as to reduce the work hardening caused by the rolling and at the same time to create a rollable structure by avoiding coarse-grained ferrite despite the ordering that causes brittleness. In addition, the strip is neither quenched, in water or oil, for example, nor pickled after intermediate annealing and the strip is therefore cold-rolled with a bright metal surface. As a result, the method can be carried out more simply and cost efficiently.

Once intermediate annealing is complete, it is therefore possible to carry out further cold deformation to the final thickness. With a method of this kind it is, in principle, possible to limit the degree of cold deformation to a final thickness of 0.50 mm or thinner such that longitudinal growth is significantly reduced at the same time. According to the invention, cold deformation should be no more than 80%, preferably up to 60%, as shown by the following examples and test results.

TABLE 1

| | | Intermediate annealing on a thickness of | | | | |
|---|---|---|---|---|---|---|
| Final thickness | No int. ann. | 1.0 mm | 0.5 mm | 0.35 mm | 0.20 mm | 0.10 mm |
| 0.35 mm | 83% | 65% (*) | 30% (*) | — | — | — |
| 0.20 mm | 90% | 80% (*) | 60% (*) | 43% (*) | — | — |
| 0.10 mm | 95% | 90% | 80% (*) | 71% (*) | 50% (*) | — |
| 0.05 mm | 98% | 95% | 90% | 86% | 75% (*) | 50% (*) |

Table 1 shows the degree of cold deformation dependent on final thickness and intermediate annealing. The hot-rolling thickness is assumed to be 2 mm. Values marked with an (*) represent states according to the invention.

The material used is a strip of the alloy VACODUR 49, which has a composition of 48.6 wt % Co, 1.86 wt % V, 0.09 wt % Nb, C<0.0070 wt %, remainder Fe and impurities. The strip was hot-rolled to a thickness of 2 mm and then quenched in an ice and saltwater bath at a temperature of above 700° C. It was then possible to cold-roll the strip to a thickness of 0.35 mm.

The intermediate continuous annealing was tested in a continuous furnace with an annealing zone of 6 min length. The temperatures selected were 850° C., 900° C., 950° C., 1000° C. and 1050° C. at a speed of 6 m/min. Annealing was carried out in dry H₂. The various intermediate continuous annealing temperatures are referred to below as variants 1 to 5.

Table 2 shows the measured mechanical properties of the continuously annealed strips of variants 1 to 5. The tensile samples were removed longitudinally to the direction of rolling. The bending cycles were determined on strips (longitudinally/transverse to the direction of rolling). No transverse 900° C. 6 m/min bend test sample was available.

FIG. 2 shows a graph plotting the yield strength R_{p0.2} and the tensile strength Rₘ of the tensile samples against the temperature T of continuous annealing at 6 m/min. The Ref. value denotes the state of a sample that has not undergone continuous annealing and is thus a comparison state.

The mechanical properties of these samples with a thickness of 0.35 mm show that all the continuously annealed variants (1-5) exhibit high elongation at fracture of the material. In addition, in variants 1, 3, 4 and 5 the difference between Rₘ and Rp_{0.2} is relatively large (>400 MPa), indicating good plastic deformability.

TABLE 2

| | | | | | | | | #Bending |
|---|---|---|---|---|---|---|---|---|
| | Intermediate | | E | | | | | test sample |
| | continuous | Hardness | modulus | R_{p0.2} | Rₘ | Rₘ − R_{p0.2} | | removal long./ |
| Variant | annealing | VH10 | GPa | MPa | MPa | MPa | A % | transv. |
| Reference | Full hard | 342 | 214 | 1119 | 1194 | 75 | 1.6 | >20/3-7 |
| 1 | 850° C., | 337 | 243 | 868 | 1322 | 454 | 16.0 | >20/15 |
| | 6 m/min | | | | | | | |
| 2 | 900° C., | 256 | 223 | 514 | 798 | 284 | 8.0 | 3/n.v. |
| | 6 m/min | | | | | | | |
| 3 | 950° C., | 233 | 219 | 459 | 865 | 406 | 10.6 | 2-7/2 |
| | 6 m/min | | | | | | | |
| 4 | 1000° C., | 247 | 197 | 492 | 1084 | 592 | 18.5 | >20/>20 |
| | 6 m/min | | | | | | | |
| 5 | 1050° C., | 266 | 224 | 576 | 1005 | 429 | 11.9 | >20/>20 |
| | 6 m/min | | | | | | | |

Further evidence of the differences in ductility is provided by the bending cycle number in the alternating bend test. The states indicated for variants 1, 4 and 5 show a high number of possible bending cycles in both directions.

A metallographic examination shows that the different variants have very different structures, which can be divided into three groups.

In variant 1, intermediate annealing at low temperatures results in only incomplete recrystallisation. For example, the structure in question was achieved at a temperature of 850° C.

In variants 2 and 3, intermediate annealing at 900° C. or 950° C. results in a ferritically recrystallised, coarse-grained structure.

In variants 4 and 5, intermediate annealing in the two-phase region α/γ results in a mixed structure with fractions of the former γ-phase in a α=matrix. For example, the structure in question was achieved at a temperature of 1000° C.

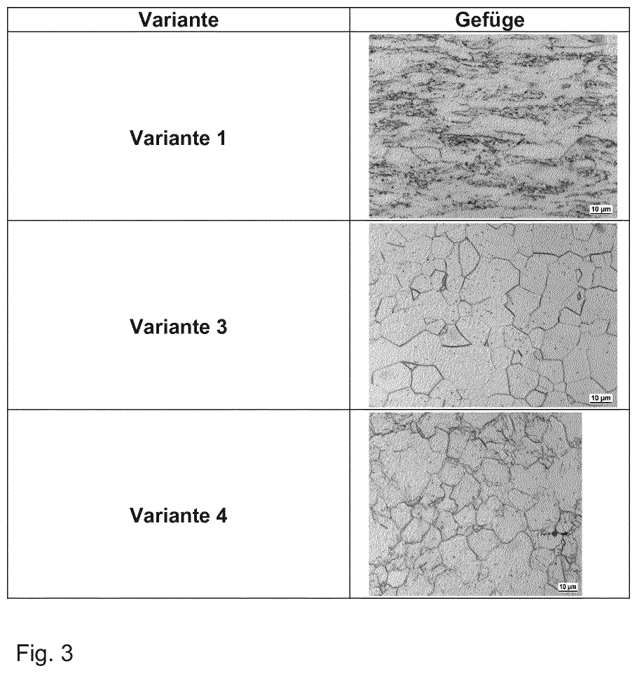

FIG. 3 shows optical images of the structure of three samples after intermediate annealing at various temperatures. Variant 1 was heat-treated at 850° C. and 6 m/min, and exhibits good rollability, N>20, a deformation structure and the start of recrystallisation. Variant 3 was heat treated at 950° C. and 6 m/min, exhibits poor rollability and N=2-7, and is ferritically recrystallised. Variant 4 was heat treated at 1000° C. and 6 m/min, and exhibits good rollability, N>20, a non-uniform ferrite and a mixed structure with fractions of the former γ-phase in a α-matrix.

Table 3 shows the influence of additional cold deformation on the mechanical properties of continuously annealed VACODUR 49. All annealed strips were rolled on a commercial 20-roller roll stand. The material exhibits strong hardening at the very first pass, indicating that the material is in the ordered state.

TABLE 3

| | Continuous | Strip | | E modulus | R_{p0.2} | Rm | |
|---|---|---|---|---|---|---|---|
| Variant | annealing | thickness | Hardness VH | GPa | MPa | MPa | A % |
| Reference | as rolled | 0.35 | 342 | 214 | 1119 | 1194 | 1.6 |
| 1 | 850° C. | 0.35 | 337 | 243 | 868 | 1322 | 16.0 |
| | 6 m/min | 0.27 | 461 | 210 | 1541 | 1570 | 0.6 |
| | | 0.20 | 443 | 214 | 1505 | 1549 | 0.6 |
| | | 0.10 | 424 | 215 | 1399 | 1470 | 0.8 |
| 2 | 900° C. | 0.35 | 256 | 223 | 514 | 798 | 8.0 |
| | 6 m/min | 0.33 | 414 | 213 | 1189 | 1269 | 4.8 |
| 4 | 1000° C. | 0.35 | 247 | 197 | 492 | 1084 | 18.5 |
| | 6 m/min | 0.10 | 368 | 200 | 1157 | 1217 | 0.6 |

The strips produced according to variants 1, 4 and 5 could be rolled to a thickness of 0.10 mm. In contrast, variants 2 and 3 exhibited strong brittleness and reacted sensitively to traction. Consequently, the material of variant 2 could not be rolled and the material of variant 3 could only be rolled under certain circumstances.

Surprisingly, therefore, the tests showed that it is possible to roll a CoFe strip after continuous annealing as long as the formation of a coarse-grained structure is avoided.

Longitudinal growth after further heat treatment to adjust the magnetic properties at a temperature of between 700° C. and 900° C., i.e. after final annealing, will now be examined.

Table 4 shows the longitudinal growth (measured in the longitudinal direction) after final magnetic annealing of VACODUR 49, hot-rolling thickness 2 mm. Both variants, i.e. variants 1 and 4, show clearly reduced growth at a smaller strip thickness.

TABLE 4

| | | | | Variant 1: | | Variant 4: | |
|---|---|---|---|---|---|---|---|
| | | Reference: | | Intermediate | | Intermediate | |
| | | No intermediate | | annealing to 0.35 | | annealing to 0.35 | |
| | | annealing | | mm at 850° C. at 6 m/min | | mm at 1000° C. at 6 m/min | |
| Final thickness | | CD | dl/l₀ | CD | dl/l₀ | CD | dl/l₀ |
| 0.35 | mm | 83% | 0.129% | 0% | 0.035% | 0% | 0.032% |
| 0.20 | mm | 90% | 0.145% | 43% | 0.055% | 43% | 0.037% |
| 0.10 | mm | 95% | 0.195% | 71% | 0.054% | 71% | 0.000% |
| 0.055 | mm | — | — | — | — | 84% | 0.159% |

The strip thus obtained was characterised in terms of longitudinal growth at an intermediate thickness of 0.25 mm and at different final thicknesses of 0.20 mm and 0.10 mm. Measurements were taken on single strips with a length of 165 mm, their length being measured exactly before and after final annealing (6 h at 880° C. in H₂). The variation in length dl can be determined from the difference between the measured lengths. Relating variation in length dl to starting length l₀ gives the relative longitudinal growth dl/l₀. The measurements given in Table 4 were all taken in the longitudinal direction, i.e. growth was determined longitudinally to the direction of rolling.

In the conventionally produced, i.e. without intermediate annealing, reference material, longitudinal growth at a thickness of 0.35 mm is already 0.129%. As cold deformation increases, growth increases to 0.195% at a thickness of 0.10 mm.

Variant 1 according to the invention, on the other hand, exhibits a variation in length clearly reduced in amount at a final thickness of 0.10 mm. An average growth dl/l₀ in the longitudinal direction of 0.054% was measured on the strip after magnetic final annealing to 0.10 mm, form example.

The strip in variant 4 also shows reduced growth. An average growth dl/l₀ in the longitudinal direction of 0.000% was measured, the individual values lying between +0.013% and −0.010%.

If cold deformation after intermediate annealing is too high, growth increases strongly again. In the embodiment for variant 4 (intermediate annealing at 1000° C. 6 and m/min to 0.35 mm), a very pronounced longitudinal growth dl/l₀ of 0.159% in the longitudinal direction is again obtained at a final thickness of 0.055 mm, i.e. at 84% cold deformation.

The anisotropy of the growth, i.e. the difference between the longitudinal growth longitudinally and transversely in relation to the strip, will now be examined.

Table 5 shows the longitudinal growth of the VACODUR 49 samples after additional final annealing for 6 h at 880° C. measured on tensile samples or longitudinal strips measuring 165 mm×20 mm. The full hard state, 0.10 mm, was measured on a comparable sample made of VACOFLUX 48, also after final annealing for 6 h at 880° C.

TABLE 5

| | | | Growth after additional | | |
|---|---|---|---|---|---|
| | | | final annealing | | |
| | | | (6 h 880° C.) | | |
| | Continuous | Final | | | \|long − |
| Variant | annealing | thickness | Long. | Trans. | trans\| |
| Reference | No intermediate | 0.35 mm | 0.129% | 0.106% | 0.023% |
| | annealing | 0.10 mm | 0.210% | 0.110% | 0.100% |
| 1 | 850° C., 6 m/min | 0.35 mm | 0.035% | 0.051% | 0.016% |
| | | 0.10 mm | 0.054% | 0.052% | 0.002% |
| 4 | 1000° C., 6 m/min | 0.35 mm | 0.032% | 0.058% | 0.026% |
| | | 0.10 mm | 0.000% | 0.056% | 0.056% |

Variant 1 in Table 5 exhibits the advantageous property of growth in longitudinal and transverse direction being almost identical. The difference in growth between the longitudinal and transverse directions |long−trans| at a strip thickness of 0.10 mm is only 0.002%. It is, therefore, possible to provide punching tools that are accordingly symmetrical. Punched round parts continue to be round after final annealing.

Variant 4 in Table 5 exhibits slight residual anisotropy, but also a clearly small longitudinal growth in terms of amount. At approx. 0.06% of the starting length, the difference between the longitudinal and transverse directions |long−trans| is substantially less than the difference observed in conventionally produced strips of approx. 0.10%.

Magnetically, at final thickness both variants show properties corresponding to those obtained in the starting material at a thickness 0.35 mm with continuous annealing. The next figure shows the corresponding new curves after final magnetic annealing at various strip thicknesses.

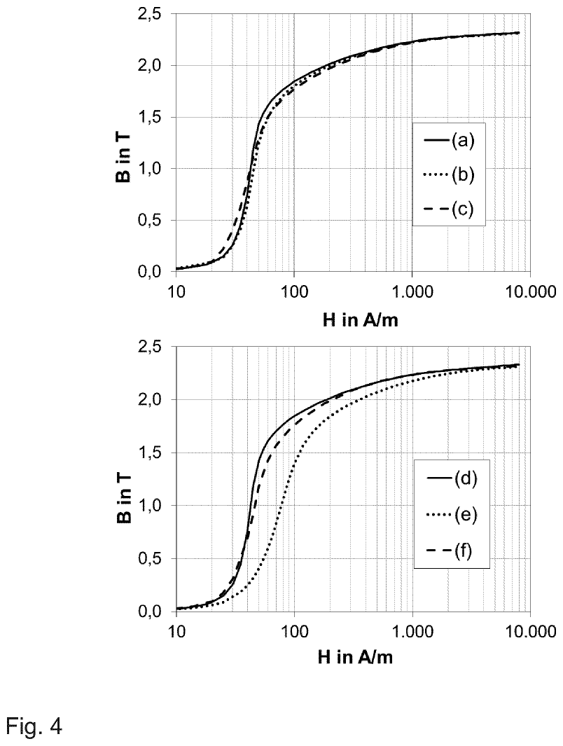

FIG. 4 shows magnetisation curves and the influence of further cold deformation on the new curve B(H) of a continuously annealed strip (850° C., 1050° C.; 6 m/min). The measurements were carried out on punch rings after final annealing for 6 hours at 880° C. in a dry H₂ atmosphere.

In FIG. 4 the letters below have the following meanings.
(a) a sample with a strip thickness of 0.35 mm that has not undergone continuous annealing (reference),
(b) a sample with a strip thickness of 0.35 mm which has undergone continuous annealing at 850° C. and 6 m/min (reference),
(c) a sample with a strip thickness of 0.35 mm that has undergone continuous annealing at 850° C. and 6 m/min and then been cold-formed to a strip thickness of 0.20 mm (according to the invention),
(d) a sample with a strip thickness of 0.35 mm which has not undergone continuous annealing (reference),
(e) a sample with a strip thickness of 0.35 mm which has undergone continuous annealing at 1050° C. and 6 m/min (reference),
(f) a sample with a strip thickness of 0.35 mm that has undergone continuous annealing at 1050° C. and 6 m/min and then been cold-formed to a strip thickness of 0.20 mm (according to the invention).

These results show that the method according to the invention has little influence on the magnetisation curve and that the strip can therefore be provided with suitable magnetic properties.

The second approach according to the invention consists of reducing the hot-rolling thickness so that at a final thickness of 0.50 mm or thinner cold deformation at final thickness is no more than 80%. In CoFe alloys the thickness of the hot-rolled strip is typically 2 mm to 4 mm. By reducing it to 1 mm at a final thickness of 0.35 mm, it is possible to achieve a reduction of the degree of cold deformation and so of longitudinal growth.

Hot-rolled strips were produced in the thicknesses indicated in Table 6 (HR thickness) and cold-rolled to different final thicknesses.

TABLE 6

| | HR | HR | HR | HR |
|---|---|---|---|---|
| Final | thickness | thickness | thickness | thickness |
| thickness | 3.5 mm | 2.0 mm | 1.5 mm | 1.0 mm |
| 0.35 mm | 90% | 83% | 77% (*) | 65% (*) |
| 0.20 mm | 94% | 90% | 87% | 80% (*) |
| 0.10 mm | 97% | 95% | 93% | 90% |
| 0.05 mm | 99% | 98% | 97% | 95% |

Table 6 shows degree of cold deformation dependent on final thickness and hot-rolling thickness (without intermediate annealing). The values marked with an (*) represent strips according to the invention.

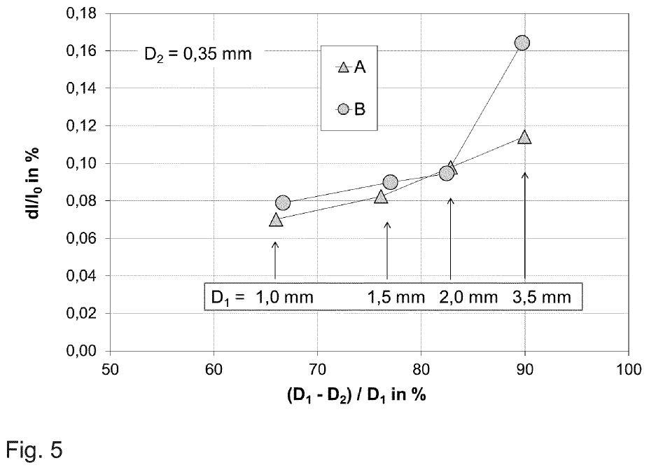

FIG. 5 shows a graph plotting the longitudinal growth (dl/l₀) of strips of different hot-rolling thickness made of VACOFLUX 50 longitudinally to the direction of rolling after final annealing against the degree of cold deformation (D₁−D₂)/D₁. The variation in length in the direction of rolling compared to the degree of cold deformation is given for two different samples A and B after final magnetic annealing. At a constant cold-rolling thickness D₂ of 0.35 mm, the hot-rolling thickness D₁ was varied between 1.0 mm and 3.5 mm. The corresponding hot-rolling thickness (HR-thickness) for each data point is indicated by an arrow.

These results reveal that the variation in HR thickness D₁ from 3.5 mm to 2.0 mm alone leads to a clear reduction in growth on a sample with a final thickness D₂ of 0.35 mm. For a HR thickness of 1.0 mm or thinner, it is possible to obtain a longitudinal growth after final annealing of <0.08% at a final thickness of 0.35 mm.

In a further examination, by way of example a HR strip with a thickness of 1.5 mm made of VACOFLUX 50 was rolled to a final thickness of 0.50 mm and subjected to final magnetic annealing (4 h 820° C., H₂). The longitudinal growth during this test was only 0.045%. Overall, it is apparent that it is possible to achieve a strong reduction in longitudinal growth for a final thickness of 0.50 mm or thinner with a correspondingly small hot-rolling thickness.

In summary, in a particular example the strip according to the invention is produced in the following manner:
hot-rolling to a thickness of 2.5 mm to 1.0 mm,
quenching from temperatures of above 700° C.,
rolling to an intermediate thickness (1.0 mm to 0.20 mm)
continuous annealing at 700° C. to 1100° C., preferably so as to create an incompletely recrystallised or fine-grained recrystallised ferritic structure rather than a coarse-grained ferritic structure,
rolling to a final thickness with a cold deformation of up to 80%, preferably with a cold deformation of up to 60%.

Alternatively, with a hot-rolled strip thickness of below 2 mm it is possible to dispense with the continuous annealing as long as the cold deformation is no more than 80%, preferably no more than 60%.

The strip according to the invention has the following properties:
composition as for standard CoFe strips with approx. identical fractions of iron and cobalt and the addition of approx. 2 wt % vanadium,
final strip thickness 0.50 mm or thinner, preferably 0.356 mm or thinner,
Vickers hardness >300 VH,
elongation at fracture <5%,
permanent growth in longitudinal direction after final magnetic annealing <0.08%, preferably <0.06%,
permanent growth in transverse direction after final magnetic annealing <0.08%, preferably <0.06%.
difference between permanent growth in longitudinal direction and permanent growth in the transverse direction <0.06%, preferably <0.04%.

1. A method for producing a CoFe alloy comprising:
casting a molten material in a vacuum and its subsequent solidification to form an ingot,
the molten material consisting essentially of 35 wt %≤Co≤55 wt % 0 wt %≤Ve≤3 wt %, 0 wt %≤Ni≤2 wt %, 0 wt %≤Nb≤0.50 wt %, 0 wt %≤Zr+Ta≤1.5 wt %, 0 wt %≤Cr≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % impurities, wherein these impurities can comprise one or more from the group O, N, S, P, Ce, Ti, Mg, Be, Cu, Mo and W,
hot-rolling the ingot to form a slab and then a hot-rolled strip with a thickness D₁, followed by the quenching of the strip from a temperature of above 700° C. to a temperature of less than 200° C.,
cold-rolling the hot-rolled strip to form an intermediate strip with a thickness D₂,
intermediate annealing the intermediate strip continuously at a temperature of above 700° C., the intermediate strip being cooled in a gaseous medium at a temperature of above 700° C. to a temperature of less than 200° C., and
cold-rolling the heat-treated intermediate strip with a bright metallic surface to form a strip with a thickness D₃, the degree of cold deformation being (D₂−D₃)/D₂≤80%.

2. A method according to claim 1, wherein 1.0 mm≤D₁≤2.5 mm.

3. A method according to claim 1, wherein 0.1 mm≤D₂≤1.0 mm.

4. A method according to claim 1, wherein 0.05 mm ≤D_{3≤0.5} mm.

5. A method according to claim 1, wherein the thickness of the hot-rolled strip is reduced from D₁ to D₂ by means of the cold-rolling.

6. A method according to claim 1, wherein the thickness of the intermediate strips is reduced from D₂ to D₃ by means of cold-rolling.

7. A method according to claim 1, wherein, after the intermediate annealing, the intermediate strip has a structure in which a ferritically recrystallised fraction has an average grain size of less than 10 μm.

8. A method according to claim 1, wherein, after the intermediate annealing, the intermediate strip has a structure in which a ferritically recrystallised fraction has no grains of a size greater than 10 μm.

9. A method according to claim 1, wherein, after the intermediate annealing, the intermediate strip undergoes a number of at least 20 bends in an alternating bend test before breaking.

10. A method according to claim 1, wherein the intermediate continuous annealing is carried out at a speed of 1 m/min to 10 m/min.

11. A method according to claim 1, wherein the length of time the strip spends in the heating zone of the continuous furnace at a temperature of 700° C. to 1100° C., is between 30 seconds and 5 minutes.

12. A method according to claim 1, wherein the intermediate continuous annealing of the intermediate strip takes place at a temperature of 800° C. to 900° C. or 1000° C. to 1100° C.

13. A method according to claim 1, wherein, after the intermediate annealing, the strip substantially has a deformation structure or a mixed structure with fractions of a former γ-phase in a α-matrix.

14. A method according to claim 1, wherein, after the intermediate annealing in a continuous process, the intermediate strip is cooled to a temperature of less than 200° C. in air.

15. A method according to claim 1, wherein the intermediate annealing takes place in an inert gas or a dry hydrogen-containing atmosphere.

16. A method for producing a CoFe alloy comprising:
providing a molten material consisting essentially of 35 wt %≤Co≤55 wt %, 0 wt %≤V≤3 wt %, 0 wt %≤Ni≤2 wt %, 0 wt %≤Nb≤0.50 wt %, 0 wt %≤Zr+Ta≤1.5 wt %, 0 wt %≤Cr≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % of impurities, wherein the impurities can contain one or more from the group O, N, S, P, Ce, Ti, Mg, Be, Cu, Mo and W,
casting the molten material in a vacuum and its subsequent solidification to form an ingot,
hot-rolling the ingot to form a slab and then a strip with a thickness D₁, where 1 mm ≤D₁<2 mm, followed by the quenching of the strip from a temperature of above 700° C. to a temperature of less than 200° C.,
cold-rolling the strip and the reduction of the thickness from D₁ to a thickness D₂, the degree of cold deformation being (D₁−D₂)/D_{1≤80}%.

17. A method according to claim 16, wherein 0.05 mm≤D₂≤0.5 mm.

18. A method according to claim 1, further comprising: the forming of at least one sheet from the strip.

19. A method according to claim 18, wherein the sheet is punched out of the strip.

20. A method according to claim 18 also comprising: the assembling of a plurality of sheets to form a stack of sheets.

21. A method according to claim 1, further comprising: heat treating the strip at a temperature of between 700° C. and 900° C.

22. A method according to claim 21, wherein, after the heat treatment of the strip, a permanent growth dl/l₀ is less than 0.08% in the longitudinal direction of the strip and/or less than 0.08% in the transverse direction of the strip, l₀ denoting the starting length before heat treatment, dl the absolute variation in length after heat treatment and dl/l₀ the relative variation in length in relation to the starting length.

23. A method according to claim 21, wherein, after the heat treatment of the strip, a difference between permanent growth in the longitudinal direction and permanent growth in the transverse direction of the strip is less than 0.06%.

24. A method according to claim 1, wherein the heat treatment of the strip take place in a dry hydrogen-containing atmosphere.

25. A semi-finished product comprising:
at least one metal strip consisting essentially of 35 wt %≤Co≤55 wt %, 0 wt %≤V≤3 wt %, 0 wt %≤Ni≤2 wt %, 0 wt %≤Nb≤0.50 wt %, 0 wt %≤Zr+Ta≤1.5 wt %, 0 wt %≤Cr ≤3 wt %, 0 wt %≤Si≤3 wt %, 0 wt %≤Al≤1 wt %, 0 wt %≤Mn≤1 wt %, 0 wt %≤B≤0.25 wt %, 0 wt %≤C≤0.1 wt %, remainder Fe and up to 1 wt % of impurities, wherein the impurities can contain one or more from the group O, N, S, P, Ce, Ti, Mg, Be, Cu, Mo and W, wherein the metal strip has a thickness d where 0.05 mm≤d≤0.5 mm, a Vickers hardness greater than 300, an elongation at fracture of less than 5% and, after heat treatment of the strip at a temperature of between 700° C. and 900° C., a permanent growth dl/l₀ in the longitudinal direction of the strip of less than 0.08%, and/or in the transverse direction of the strip of less than 0.08%, l₀ designating the starting length before heat treatment, dl the absolute variation in length after heat treatment and dl/l₀ the relative variation in length in relation to the starting length.

26. A semi-finished product according to claim 25, wherein 0.05 mm≤d≤0.356 mm.

27. A semi-finished product according to claim 25, wherein the semi-finished product comprises a plurality of sheets that form a stack of sheets.

28. A semi-finished product according to claim 25, wherein, after the heat treatment of the strip at a temperature of between 700° C. and 900° C., a difference between the permanent growth in the longitudinal direction and the permanent growth in the transverse direction of the strip is less than 0.06%.
